(19) United States
(12) Patent Application Publication
(10) Pub. No.: US 2025/0293914 A1
(43) Pub. Date: Sep. 18, 2025

(54) SRS INTERFERENCE RANDOMIZATION FOR CJT OPERATION

(71) Applicant: Telefonaktiebolaget LM Ericsson (publ), Stockholm (SE)

(72) Inventors: Andreas NILSSON, Göteborg (SE); Sven JACOBSSON, Västra Frölunda (SE); Shiwei GAO, Nepean (CA); Siva MURUGANATHAN, Stittsville (CA)

(21) Appl. No.: 18/860,299

(22) PCT Filed: Apr. 28, 2023
(86) PCT No.: PCT/IB2023/054477

§ 371 Date: Oct. 25, 2024

Related U.S. Application Data
(60) Provisional application No. 63/336,849, filed on Apr. 29, 2022.

(51) Int. Cl. H04L 27/26; H04L 5/00

(52) U.S. Cl. CPC H04L 27/26134; H04L 5/0048

(57) ABSTRACT

A method, system and apparatus are disclosed. According to some embodiments, a network node is configured to cause transmission of a configuration to a wireless device for sounding reference signal, SRS, transmission over a plurality of symbols in one or more slots, where the configuration indicates a SRS resource set including at least one SRS resource and temporal hopping of the SRS transmission over the plurality of symbols; receive the SRS transmission according to the configuration; and perform SRS measurements based on the received SRS transmission.

### CROSS-REFERENCE TO RELATED APPLICATION

This application claims priority to U.S. Provisional Application No. 63/336,849, filed Apr. 29, 2022, which is hereby incorporated by reference in its entirety.

### FIELD

The present disclosure relates to wireless communications, and in particular, to reference signal resource configurations based on temporal hopping (e.g., cyclic shift hopping, comb offset hopping, etc.).

### BACKGROUND

The Third Generation Partnership Project (3GPP) has developed and is developing standards for Fourth Generation (4G) (or Long Term Evolution (LTE)) and Fifth Generation (5G) (or New Radio (NR)) wireless communication systems. Such systems provide, among other features, broadband communication between network nodes, such as base stations, and mobile wireless devices, as well as communication between network nodes and between wireless devices.

The next generation mobile wireless communication system (5G) or NR, will support a diverse set of use cases and a diverse set of deployment scenarios. The latter includes deployment at both low frequencies (100s of MHz), similar to LTE today, and very high frequencies (mm waves in the tens of GHz).

Similar to LTE, NR will use OFDM (Orthogonal Frequency Division Multiplexing) in the downlink (i.e., from a network node, or gNB, to a wireless device (e.g., user equipment or UE). It is also referred to as CP-OFDM (Cyclic Prefix OFDM). In the uplink (i.e., from wireless device to network node), both CP-OFDM and DFT-spread OFDM (DFT-S-OFDM) will be supported. DFT-S-OFDM is also referred to as Single Carrier FDMA (SC-FDMA) in LTE Downlink Transmission based on Channel Reciprocity

Sounding reference signal (SRS) is typically used for uplink channel measurements for the purpose of UL scheduling and link adaptation, in which an SRS is sent by a wireless device and the UL channel is measured by the network node to determine the UL CSI. In time division duplexing (TDD) systems, DL and UL channel is reciprocal and thus, SRS can also be used to obtain DL CSI, at least DL PMI. Comparing to CSI-RS based DL CSI feedback, this saves CSI feedback overhead and also potentially feedback latency.

SRS is supported in NR for uplink channel sounding. Similar to LTE, configurable SRS bandwidth is supported in NR. SRS can be configurable with regard to density in frequency domain (e.g., comb levels) and/or in time domain (including multi-symbol SRS transmissions).

A wireless device can be configured with one or more SRS resource sets, each SRS resource set can contain one or more SRS resources. Each SRS resource can contain Nₐₚ^{SRS}∈ {1,2,4} SRS antenna ports in a time-frequency resource with N_{symb}^{SRS}∈{1,2,4,8,10,12,14} consecutive OFDM symbols in a slot starting from OFDM symbol l₀ and a number PRBs starting from subcarrier k₀.

An SRS sequence for an SRS antenna port pᵢ at OFDM symbol l′ in an SRS resource is a cyclic shifted version of a Zadoff-Chu sequence r̅_{u,v}(n) with a group number u∈{0,1, . . . ,29} and a base sequence number v∈{0,1} within the group, i.e.,

$${r}^{( {p}_{i} )} ( n , {l}^{′} ) = {r}_{u , v}^{( {α}_{i} , δ )} ( n ) = {e}^{j α n} {\overline{r}}_{u , ν} ( n ) , \\ 0 \leq n < {M}_{ZC}$$

l′∈{0,1, . . . , N_{symb}^{SRS}−1}

where M_{ZC}=mN_{sc}^{RB}/2^{δ} is the length of the sequence, m is the number of RBs configured for the SRS resource, N_{sc}^{RB}=12 is the number sub-carriers per RB, δ=log₂(K_{TC}) and K_{TC}∈ {2,4,8} is a configured comb value where the SRS sequence occupies every K_{TC} sub-carriers, αᵢ=2πn_{SRS}^{cs,i}/n_{SRS}^{cs,max} is a cyclic shift and n_{SRS}^{cs,max} is maximum number of cyclic shifts that can be configured as shown in Table 6.4.1.4.2-1 in 3GPP TS38.211 V17.0.0 and n_{SRS}^{cs,i}∈ {0,1, . . . , n_{SRS}^{cs,max}−1}

TABLE 6.4.1.4.2-1
Maximum number of cyclic shifts n_{SRS}^{cs, max} as a function of K_{TC}.

| K_{TC} | n_{SRS}^{cs, max} |
|---|---|
| 2 | 8 |
| 4 | 12 |
| 8 | 6 |

In cases of two SRS ports contained in a SRS resource, the two SRS ports are mapped to the same comb offset but allocated with two different cyclic shifts separated by π. In case of four SRS ports contained in a SRS resource, two possible port-allocation options are supported (unless the transmission comb is 8 (supported since 3GPP NR Rel-17 (i.e., 3GPP Release 17)) for which only the second option is supported). In a first option, the four SRS ports are mapped to the same comb offset but allocated four different cyclic shifts separated by π/2. In a second option, the first two SRS ports are allocated with two different cyclic shifts separated by π on a same set of sub-carriers (with a same first comb offset) and the last two SRS ports are allocated with the same two different cyclic shifts as the first two SRS ports but on a different set of sub-carriers (with a same second comb offset).

The definition of the base sequence \hat{r}_{u,v}(0), . . . , \hat{r}_{u,v}(M_{ZC}˜1) depends on the sequence length M_{ZC} and is described in 3GPP standards such as in, for example, section 5.2.2 of 3GPP TS38.211 V17.0.0. M_{ZC}=M_{sc,b}^{SRS}−1 and M_{sc,b}^{SRS} is the number of subcarriers configured for the SRS resource.

In NR, the sequence group u is given by

$$u = ( {f}_{gh} ( {n}_{s , f}^{μ} , {l}^{′} ) + {n}_{ID}^{SRS} ) mod 30$$

where n_{ID}^{SRS}∈{0, 1, . . . , 1023} is configured by higher layers, and n_{s,f}^{μ} is the slot number in a radio frame.

### Srs Group and Sequence Hopping

If both group and sequence hopping are disabled, then

$$\begin{matrix}{f}_{gh} ( {n}_{s , f}^{μ} , {I}^{′} ) = 0 \\ v = 0\end{matrix}$$

If group hopping is enabled and sequence hopping is disabled

$$\begin{matrix}{f}_{gh} ( {n}_{s , f}^{μ} , {l}^{′} ) = ( {\sum }_{m - 0}^{7} c ( 8 ( {n}_{s , f}^{μ} {N}_{symb}^{slot} + {l}_{0} + {l}^{′} ) + m ) \cdot {2}^{m} ) mod 30 \\ v = 0\end{matrix}$$

where the pseudo-random sequence c(i) is defined in 3GPP standard(s) such as in, for example, section 5.2.1 of TS38.211 V17.0.0 and shall be initialized with cᵢₙᵢₜ=n_{ID}^{SRS} at the beginning of each radio frame, N_{symb}^{slot} is the number of OFDM symbols in a slot.

If sequence hopping is enabled and group hopping is disabled

$$\begin{matrix}{f}_{gh} ( {n}_{s , f}^{μ} , {l}^{′} ) = 0 \\ v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}\end{matrix}$$

where the pseudo-random sequence c (i) is defined in 3GPP standard(s) such as in, for example, section 5.2.1 of 3GPP TS 38.211 V17.0.0 and may be initialized with c^{init}=n_{ID}^{SRS} at the beginning of each radio frame.

For wireless devices in the same serving cell, a same SRS sequence ID, n_{ID}^{SRS}, is typically allocated for all wireless devices such that SRS ports allocated at the same time-frequency resource are orthogonal. For wireless devices in different cells, different SRS sequences are typically configured so that inter-cell SRS interferences are randomized.

### Srs Bandwidth

In general, two kinds of sounding bandwidths are supported, one is wideband, and the other is narrowband. In case of wideband, channel measurement over a large system bandwidth can be performed in a single OFDM symbol. While in narrowband sounding, only part of the full bandwidth can be measured in each OFDM symbol, thus multiple SRS OFDM symbols are needed for a full bandwidth channel measurement. Frequency hopping is supported for narrowband SRS so that different parts of the full bandwidth can be measured in different SRS OFDM symbols.

The SRS bandwidth for a wireless device is configurable and is in the multiple of 4 PRBs. The minimum SRS bandwidth is 4 PRBs, which is also referred to as SRS subband. An example of wideband and narrowband SRS with 10 MHz system bandwidth and 15 kHz subcarrier spacing is shown in the example of FIG. 1.

In case of narrowband SRS with frequency hopping (FH), an SRS is transmitted on different part of the system bandwidth at different SRS OFDM symbols. For example, for a 10 MHz system, with 15 kHz subcarriers spacing, and SRS bandwidth of 4 PRBs, a possible set of locations in the frequency domain for SRS transmission are shown in FIG. 2. In this example, the whole bandwidth can be measured after 12 SRS OFDM symbols.

Different wireless devices can be multiplexed on the same time-frequency resources by assigning different cyclic shifts. In addition, an SRS signal is only transmitted on a subset of the subcarriers in the configured SRS bandwidth (i.e., every K_{TC} subcarriers), configurable through a parameter called comb, thereby increasing the SRS multiplexing capacity provided that the channel is sufficiently flat so that channel measurement every K_{TC} subcarriers is adequate and so that ports assigned to different cyclic shifts are not interfering with each other.

### SRS Resource Types

An SRS resource can be periodic, semi-persistent, or aperiodic. In case of periodic or semi-persistent SRS, a wireless device transmits SRS periodically at certain configured SRS slots. In case of aperiodic SRS, a wireless device transmits SRS only when it is requested by a network node.

### SRS Power Control

SRS power control is used to determine a proper SRS transmit power such that the SRS is received at a desired power level at the network node. This is needed to ensure SRS from all wireless devices in a same cell are received at approximately a same power level at the network node to avoid cross wireless device interference.

SRS power control in NR consists of two parts, i.e., open-loop power control and closed-loop power control. Open-loop power control is used to set the uplink transmit power based on a pathloss estimation and some other factors including the target receive power, SRS bandwidth, fractional power control factor, etc.

Closed-loop power control is based on explicit power control commands received from the network node. The power control commands are used to adjust the SRS transmit power based actual received SRS power at the network node. Either cumulative or non-cumulative closed-loop power adjustments are supported in NR. A closed loop adjustment at a given time is also referred as a power control adjustment state.

Pathloss estimation is based on a downlink reference signal (RS). Such as a DL RS is referred to as a pathloss reference RS. A DL pathloss reference RS can be a CSI-RS or SSB.

A SRS transmission occasion i is defined by a slot index n_{s,ƒ}^{μ} within a frame with system frame number SFN, a first symbol S within the slot, and a number of consecutive symbols L.

For a SRS in an SRS resource set qₛ associated with a pathloss reference RS with index k, its transmit power in a transmission occasion I within a slot in a bandwidth part (BWP) of a carrier frequency of a serving cell and a closed-loop index l (l=0,1) can be expressed as

$$P ( i , k , l , {q}_{s} ) = min \{ \begin{matrix}{P}_{CMAX} ( i ) \\ {P}_{open - loop} ( i , k , {q}_{s} ) + {P}_{closed - loop} ( i , l )\end{matrix}$$

where P_{CMAX}(i) is the configured UE maximum output power for the carrier frequency of the serving cell in transmission occasion i. Pₒₚₑₙ₋ₗₒₒₚ(i, k) is the open loop power adjustment and P_{closed-loop}(i, l) is the closed loop power adjustment. Pₒₚₑₙ₋ₗₒₒₚ (i, k, qₛ) is given below,

$${P}_{open - loop} ( i , k , {q}_{s} ) = {P}_{O} ( {q}_{s} ) + {P}_{RB} ( i ) + α ( {q}_{s} ) PL ( k )$$

where P_{O}(qₛ) is the nominal SRS target receive power, P_{RB}(i) is a power adjustment related to the number of RBs occupied by the SRS in a transmission occasion i, PL(k) is the pathloss estimation based on a pathloss reference RS with index k, α(qₛ) is fractional pathloss compensation factor. P_{O}(qₛ), k and α(qₛ) are configured for the SRS resource set qₛ.

For SRS closed-loop power control, a wireless device can have a dedicated closed loop for SRS or share A closed loop of PUSCH in the same serving cell. This is configured by a higher layer parameter srs-PowerControlAdjustmentStates in each SRS resource set to select one out of three options, i.e., use the dedicated closed loop for SRS, the first closed loop, and the second closed loop for PUSCH. In case that the closed loop(s) are shared with PUSCH, P_{closed-loop}(i, l) for PUSCH also applies to SRS transmitted in the SRS resource set.

For the dedicated closed loop configured for SRS. P_{closed-loop}(i, l) is given below:

$${P}_{closed - loop} ( i , l ) = \{ \begin{matrix}{P}_{closed - loop} ( i - {i}_{0} , l ) + {\sum }_{m = 0}^{M} δ ( m , l ) ; if cumulation is enabled \\ δ ( i , l ) ; if cumulation is disabled ( i . e . , absolute is enabled\end{matrix}$$

where δ(i, l) is a transmit power control (TPC) command value received in DCI format 2.3 associated with the SRS at transmission occasion i and closed-loop index l; Σₘ₌₀^{M}δ(m, l) is a sum of TPC command values that the UE receives for the SRS and the associated closed-loop index I since the TPC command for transmission occasion i−i₀.

### SRS for Antenna Switching

When a wireless device has more receive branches than transmit branches, only a subset of antenna ports are used for UL transmission. This is commonly referred to as xTyR, i.e., x receive and y transmit branches, where y=mx and m is an integer. Full DL channel may not be able to be obtained based on SRS transmission on the subset of antenna ports.

One way to help solve the problem is antenna switching, in which SRS is transmitted in different subsets of antenna ports at different time. An example is shown in FIG. 3, where there are 4 antennas and one transmit chain, i.e., 1T4R. The full channel associated with the 4 antennas are sounded by transmitting a single port SRS on one antenna port at a time over 4 OFDM symbols using an antenna switch. In this example, the 4 OFDM symbols are spread over two slots. For that, two SRS resource sets need to be configured, one set for each of the two slots. Each of the two SRS resource set contains two single port SRS resources on two different OFDM symbols. The two SRS resource sets are triggered together. The same power control parameters need to be configured for the two SRS resource sets.

In general, for xTyR, full channel sounding can be achieved by transmitting SRS over x antenna ports at each OFDM symbol and over m OFDM symbols. If the m OFDM symbols are within a same slot, a single SRS resource set with m SRS resources can be configured. If the m OFDM symbols are spread in z different slots, z SRS resource sets each with y/z SRS resources can be configured.

Joint DL Transmission from Multiple TRPs

Non-coherent joint DL PDSCH transmission (NC-JT) is supported in NR Rel-16 in which a subset of layers of a PDSCH can be transmitted from a first Transmission and reception Point (TRP) and the rest of layers of the PDSCH can be transmitted from a second TRP. An example is shown in FIG. 4, where layer 1 of a PDSCH is transmitted from TRP1 while layer 2 of the PDSCH is transmitted from TRP2. When multiple antenna ports are deployed at each TRP, a precoding matrix would be applied to the PDSCH at each TRP, e.g., w₁ at TRP1 and w₂ at TRP2. The two TRPs may be in different physical locations.

In 3GPP NR Rel-18, coherent joint PDSCH transmission (CJT) from multiple TRPs is to be introduced in which a PDSCH layer can be transmitted from up to four TRPs. An example is shown in FIG. 5, where the same PDSCH layer is transmitted over two TRPs. When multiple antenna ports are deployed at each TRP, a precoding matrix would be applied to the PDSCH at each TRP. In addition, a co-phasing factor is also applied so that the PDSCH from the two TRPs are in phase and thus coherently added at the wireless device.

However, in case of reciprocity-based DL coherent joint transmission (CJT) from multiple TRPs, it may be important to attain SRS-based channel estimates from multiple different wireless devices at multiple different TRPs.

Since an SRS resource will be received at two TRPs, the difference in timing advance will result in additional interference for, at least, one of the two TRPs. Furthermore, the received power may vary significantly over the two TRPs resulting additional interference for, at least, one of the two TRPs. In short, cross-SRS interference is a potential issue for TDD CJT. Hence, there are unresolved issues with reciprocity-based DL joint transmission.

### SUMMARY

Some embodiments advantageously provide methods, systems, and apparatuses for reference signal resource configurations.

According to one or more embodiments, a method is provided to support channel sounding over multiple TRPs to support reciprocity-based DL joint transmission over the multiple TRPs while reducing/randomizing the SRS interference among the TRPs. The method may include one or more of:
Configure a wireless device with SRS resource with cyclic-shift hopping;
Configure a wireless device with SRS resource with comb-offset hopping; and
Configure a multi-port wireless device with a multi-port SRS resource with a new cyclic-shift allocation formula that is more suited for multi-TRP operation and introduce dynamic switching between new cyclic-shift allocation and legacy cyclic-shift allocation.

According to one aspect of the present disclosure, a network node in communication with a wireless device is provided. The network node includes processing circuitry configured to: cause transmission of a configuration to a wireless device for sounding reference signal, SRS, transmission over a plurality of symbols in one or more slots, where the configuration indicates: a SRS resource set including at least one SRS resource and temporal hopping of the SRS transmission over the plurality of symbols; receive the SRS transmission according to the configuration, and perform SRS measurements based on the received SRS transmission.

According to another aspect of the present disclosure, a wireless device in communication with a network node is provided. The wireless device includes processing circuitry configured to receive a configuration for sounding reference signal, SRS, transmission over a plurality of symbols in one or more slots, where the configuration indicates: a SRS resource set including at least one SRS resource and temporal hopping of the SRS transmission over the plurality of symbols, perform SRS transmission according to the configuration.

According to another aspect of the present disclosure, a method implemented by a network node in communication with a wireless device is provided. The method includes causing transmission of a configuration to a wireless device for sounding reference signal, SRS, transmission over a plurality of symbols in one or more slots, where the configuration indicates a SRS resource set including at least one SRS resource and temporal hopping of the SRS transmission over the plurality of symbols, receiving the SRS transmission according to the configuration, and performing SRS measurements based on the received SRS transmission.

According to another aspect of the present disclosure, method implemented by a wireless device in communication with a network node is provided. The method includes receiving a configuration for sounding reference signal, SRS, transmission over a plurality of symbols in one or more slots, where the configuration indicates a SRS resource set including at least one SRS resource and temporal hopping of the SRS transmission over the plurality of symbols, and performing SRS transmission according to the configuration.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of an example of wideband and narrowband SRS;

FIG. 2 is a diagram of an example of a set of locations for SRS transmission;

FIG. 3 is a diagram of an example of SRS used in antenna switching;

FIG. 4 is a diagram of an example of NC-JT;

FIG. 5 is a diagram of an example of coherent joint PDSCH transmission from two TRPs;

FIG. 6 is a schematic diagram of an example network architecture illustrating a communication system connected via an intermediate network to a host computer according to the principles in the present disclosure;

FIG. 7 is a block diagram of a host computer communicating via a network node with a wireless device over an at least partially wireless connection according to some embodiments of the present disclosure;

FIG. 8 is a flowchart illustrating example methods implemented in a communication system including a host computer, a network node and a wireless device for executing a client application at a wireless device according to some embodiments of the present disclosure;

FIG. 9 is a flowchart illustrating example methods implemented in a communication system including a host computer, a network node and a wireless device for receiving user data at a wireless device according to some embodiments of the present disclosure;

FIG. 10 is a flowchart illustrating example methods implemented in a communication system including a host computer, a network node and a wireless device for receiving user data from the wireless device at a host computer according to some embodiments of the present disclosure;

FIG. 11 is a flowchart illustrating example methods implemented in a communication system including a host computer, a network node and a wireless device for receiving user data at a host computer according to some embodiments of the present disclosure;

FIG. 12 is a flowchart of an example process in a network node according to some embodiments of the present disclosure;

FIG. 13 is a flowchart of another example process in a network node according to some embodiments of the present disclosure;

FIG. 14 is a flowchart of an example process in a wireless device according to some embodiments of the present disclosure;

FIG. 15 is a flowchart of another example process in a wireless device according to some embodiments of the present disclosure;

FIGS. 16a, 16b and 16c are diagrams of examples of different cyclic shift hopping schemes according to some embodiments of the present disclosure;

FIGS. 17a and 17b are diagrams of other examples of different cyclic shift hopping schemes according to some embodiments of the present disclosure;

FIGS. 18a, 18b and 18c are diagrams of examples of different comb hopping schemes according to some embodiments of the present disclosure;

FIGS. 19a and 19b are diagrams of other examples of different comb hopping schemes according to some embodiments of the present disclosure; and

FIG. 20 is a diagram of TRP operation.

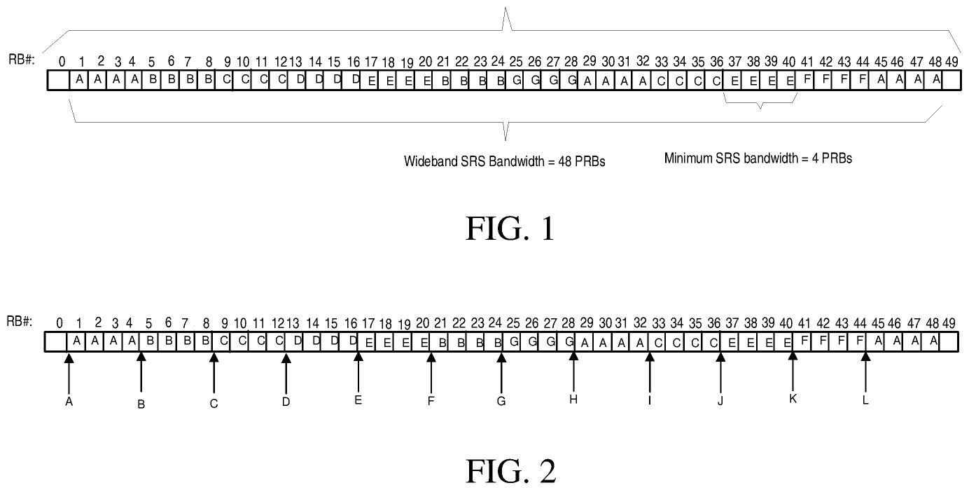

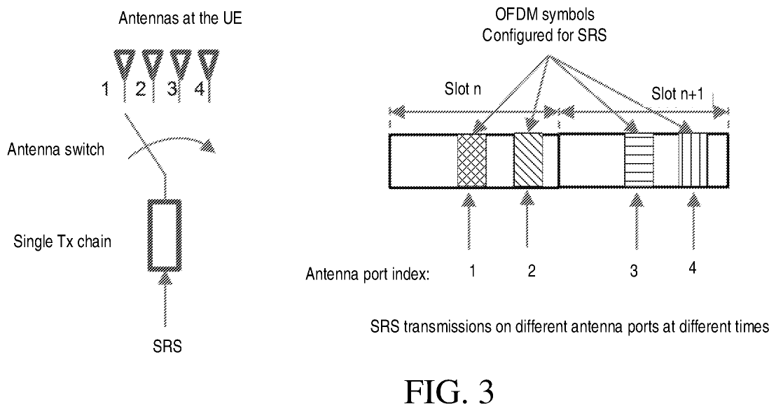

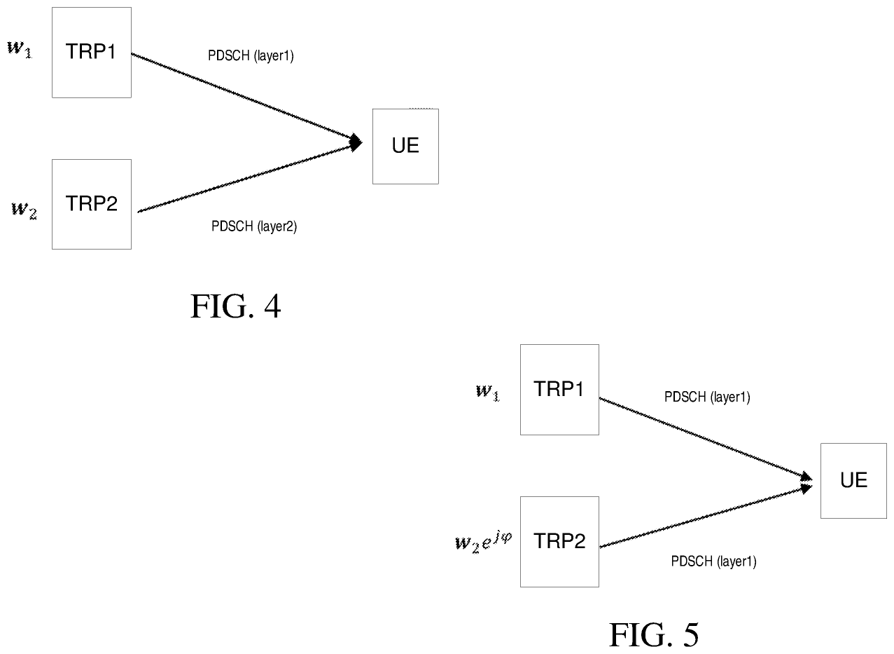

### DETAILED DESCRIPTION

As described above, there are various unresolved items with reciprocity-based joint transmission. For this reason, the NR Rel-18 work item description (WID) on multiple input-multiple output (MIMO) enhancements for downlink and uplink includes the following objective for future study:
4. Study, and if justified, specify enhancements of CSI acquisition for Coherent-JT targeting FR1 and up to 4 TRPs, assuming ideal backhaul and synchronization as well as the same number of antenna ports across TRPs, as follows:
   Rel-16/17 Type-II codebook refinement for CJT mTRP targeting FDD and its associated CSI reporting, taking into account throughput-overhead trade-off
   SRS enhancement to manage inter-TRP cross-SRS interference targeting TDD CJT via SRS capacity enhancement and/or interference randomization, with the constraints that 1) without consuming additional resources for SRS; 2) reuse existing SRS comb structure; 3) without new SRS root sequences
   Note: the maximum number of CSI-RS ports per resource remains the same as in Rel-17, i.e., 32.

Before describing in detail example embodiments, it is noted that the embodiments reside primarily in combinations of apparatus components and processing steps related to reference signal resource configurations based on and/or using temporal hopping (e.g., cyclic shift hopping, comb offset hopping, etc.). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, the singular forms “a,” “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

The term “network node” used herein can be any kind of network node comprised in a radio network which may further comprise any of base station (BS), radio base station, base transceiver station (BTS), base station controller (BSC), radio network controller (RNC), g Node B (gNB), evolved N B (eNB), N B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) or a radio network node.

In some embodiments, the non-limiting terms WD or a user equipment (UE) are used interchangeably. The WD herein can be any type of wireless device capable of communicating with a network node or another WD over radio signals). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, eNB, NB, gNB, Multi-cell/multicast Coordination Entity (MCE), IAB node, relay node, access point, radio access point, RRU, RRH.

Note that although terminology from one particular wireless system, such as, for example, 3GPP LTE and/or NR, may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide reference signal resource configurations.

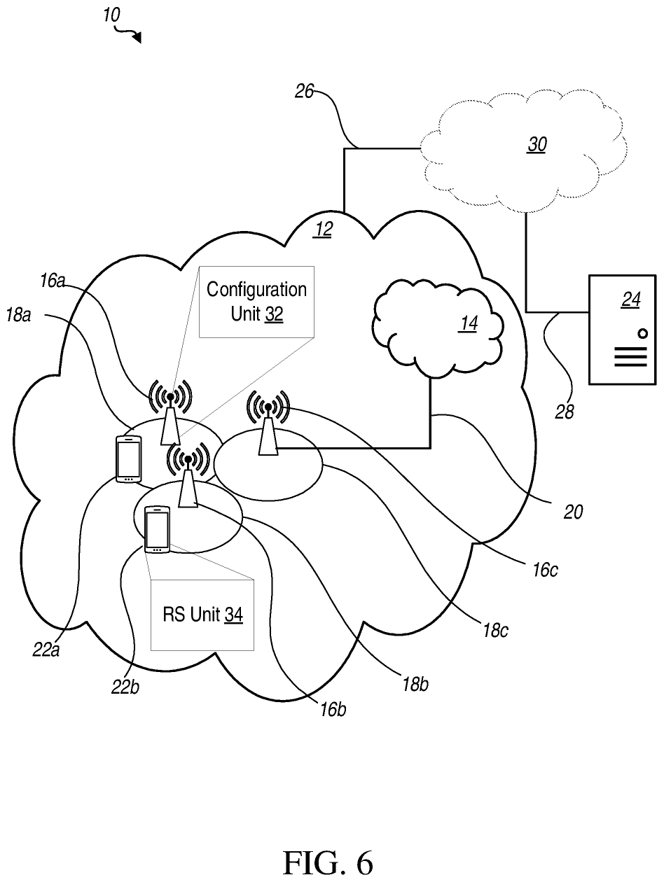

Referring again to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as WDs 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to perform one or more network node 16 functions as described herein such as with respect to reference signal resource configurations. A WD 22 is configured to include a RS unit 34 which is configured to perform one or more WD 22 functions as described herein such as with respect to reference signal resource configurations.

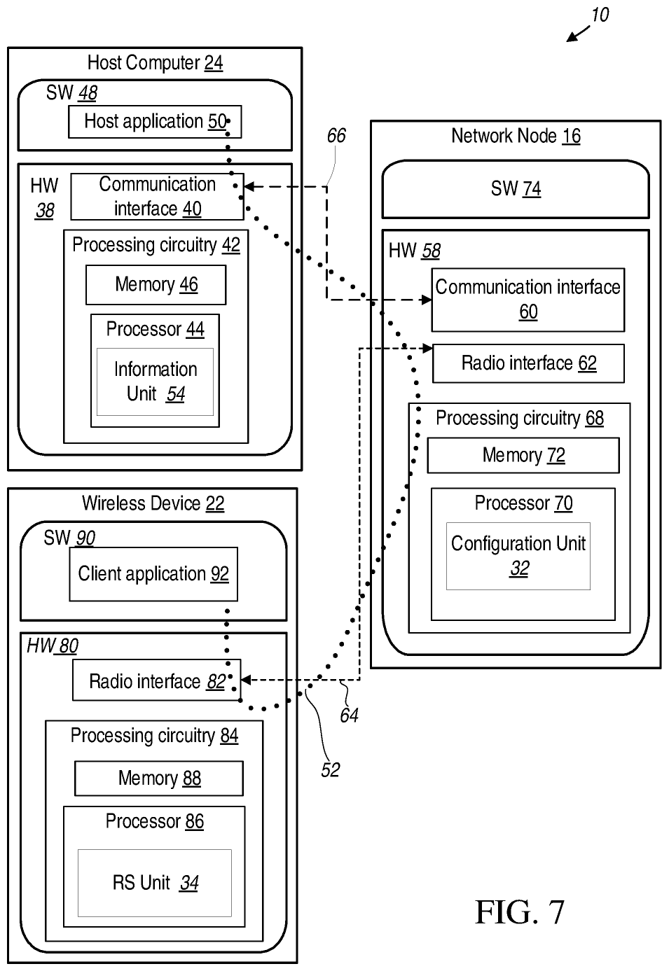

Example implementations, in accordance with an embodiment, of the WD 22, network node 16 and host computer 24 discussed in the preceding paragraphs will now be described with reference to FIG. 7. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable ROM).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the WD 22. The processing circuitry 42 of the host computer 24 may include an information unit 54 configured to enable the service provider to one or more of: store, analyze, transmit, receive, communicates, relay, forward, determine, configure, etc. information with respect to reference signal resource configurations.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs and/or ASICs adapted to execute instructions. The processor 70 may be configured to access (e.g., write to and/or read from) the memory 72, which may comprise any kind of volatile and/or nonvolatile memory, e.g., cache and/or buffer memory and/or RAM and/or ROM and/or optical memory and/or EPROM.

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform one or more network node 16 functions as described herein such as with respect to reference signal resource configurations.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 and memory 88 are similar as processing circuitry 68 and memory 72.

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the WD 22 may include a RS unit 34 configured to perform one or more wireless device functions as described herein such as with respect to reference signal resource configurations.

In some embodiments, the inner workings of the network node 16, WD 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the WD 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as configuration unit 32, and RS unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

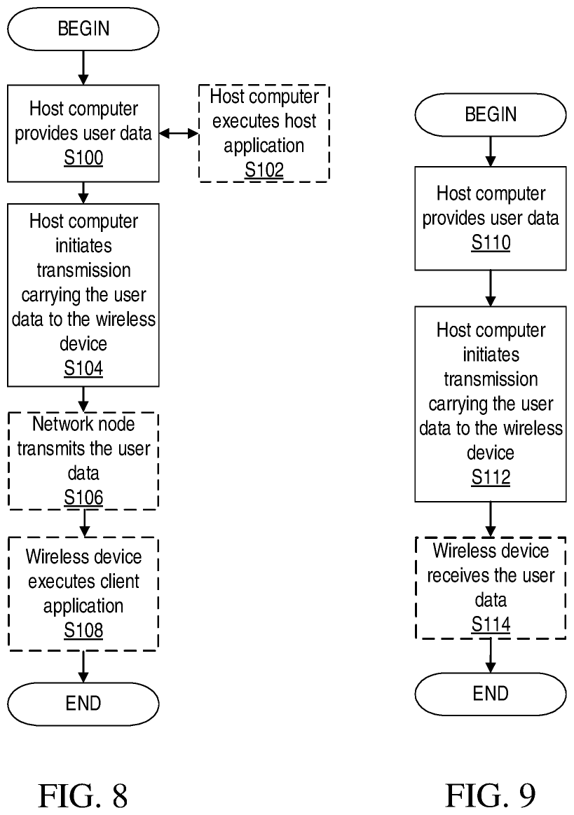

FIG. 8 is a flowchart illustrating an example method implemented in a communication system, such as, for example, the communication system of FIGS. 6 and 7, in accordance with one embodiment. The communication system may include a host computer 24, a network node 16 and a WD 22, which may be those described with reference to FIG. 7. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 9 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

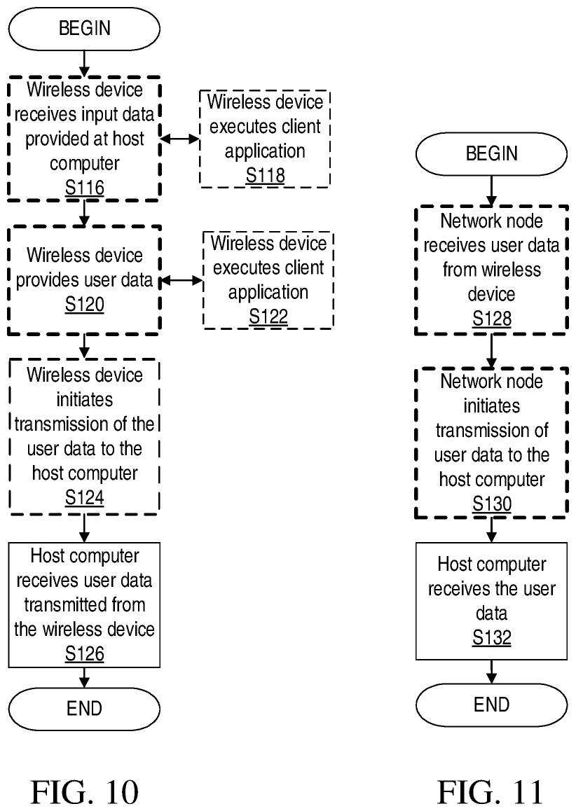

FIG. 10 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 11 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

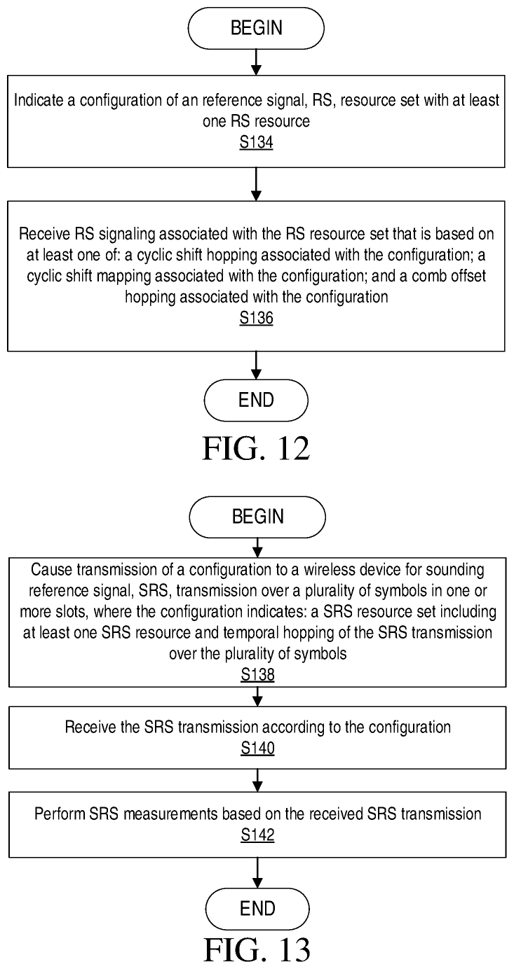

FIG. 12 is a flowchart of an example process in a network node 16 according to some embodiments of the present disclosure. One or more blocks described herein may be performed by one or more elements of network node 16 such as by one or more of processing circuitry 68 (including the configuration unit 32), processor 70, radio interface 62 and/or communication interface 60. Network node 16 is configured to indicate (Block S134) a configuration of an reference signal, RS, resource set with at least one RS resource, as described herein. Network node 16 is configured to receive (Block S136) RS signaling associated with the RS resource set that is based on at least one of: a cyclic shift hopping associated with the configuration; a cyclic shift mapping associated with the configuration; and a comb offset hopping associated with the configuration, as described herein.

According to one or more embodiments, the at least one of cyclic shift hopping, cyclic shift mapping and comb offset hopping is performed according to at least one of: per OFDM symbol per RS transmission occasion; and only per RS transmission occasion. According to some embodiments, the cycle shift hopping is configured to be performed after the occurrence of a predefined number of OFDM, symbols, e.g., after a same SRS sequence are transmitted/repeated over a same bandwidth in R consecutive OFDM symbols, within one SRS transmission occasion. According some embodiments, the comb offset is based on a predefined pseudo random hopping pattern. According to one or more embodiments, the cycle shift mapping allocates cyclic shifts for RS ports associated with a same RS resource.

FIG. 13 is a flowchart of another example process in a network node 16 according to some embodiments of the present disclosure. One or more blocks described herein may be performed by one or more elements of network node 16 such as by one or more of processing circuitry 68 (including the configuration unit 32), processor 70, radio interface 62 and/or communication interface 60. Network node 16 is configured to cause (Block S138) transmission of a configuration to a WD 22 for SRS transmission over a plurality of symbols in one or more slots, where the configuration indicates a SRS resource set including at least one SRS resource and temporal hopping of the SRS transmission over the plurality of symbols, as described herein. The network node 16 is configured to receive (Block S140) the SRS transmission according to the configuration, as described herein. The network node 16 is configured to perform (Block S142) SRS measurements based on the received SRS transmission, as described herein.

According to some embodiments, the temporal hopping is according to a configured hopping pattern over an allocated number of at least one of cyclic shifts and comb offsets for hopping, where a subset of the allocated number of at least one of cyclic shifts and comb offsets is applied at each hop.

According to some embodiments, the configured hopping pattern is: configured one of per SRS resource and SRS resource set, and applied to a plurality of SRS ports associated with one of the at least one SRS resource and SRS resource set; and the subset of the allocated number of at least one of cyclic shifts and comb offsets is applied to the plurality of SRS ports at each hop.

According to some embodiments, the configured hopping pattern is defined by a hopping offset applied at each hop to a set of initial at least one of cyclic shifts and comb offsets configured for the plurality of SRS ports.

According to some embodiments, the hopping offset is a function of at least one of a symbol index and a slot index.

According to some embodiments, the configured hopping pattern is applied within each of the one or more slots, where the hopping is performed per symbol or per every integer number of symbols.

According to some embodiments, the configured hopping pattern is applied per slot, where the hopping is performed from slot to slot.

According to some embodiments, the configured hopping pattern is applied over the plurality of symbols in the one or more slots, where the hopping is performed per symbol or every integer number of symbols across the one or more slots.

According to some embodiments, the configured hopping pattern is a pseudo random hopping pattern.

According to some embodiments, the pseudo random hopping pattern is used to perform temporal hoping of the SRS transmission over the allocated number of at least one of cycle shifts and comb offsets.

According to some embodiments, a starting position of the pseudo random hopping pattern for the at least one SRS resource is one of: based on a configured SRS sequence for the at least one SRS resource, and based on a RNTI associated with the WD 22.

According to some embodiments, the pseudo random hopping pattern is one of: the same for a plurality of SRS ports associated with the SRS resource set, the same for a plurality of SRS ports associated with the at least one SRS resource, and different from another pseudo random hopping pattern implemented for another SRS port.

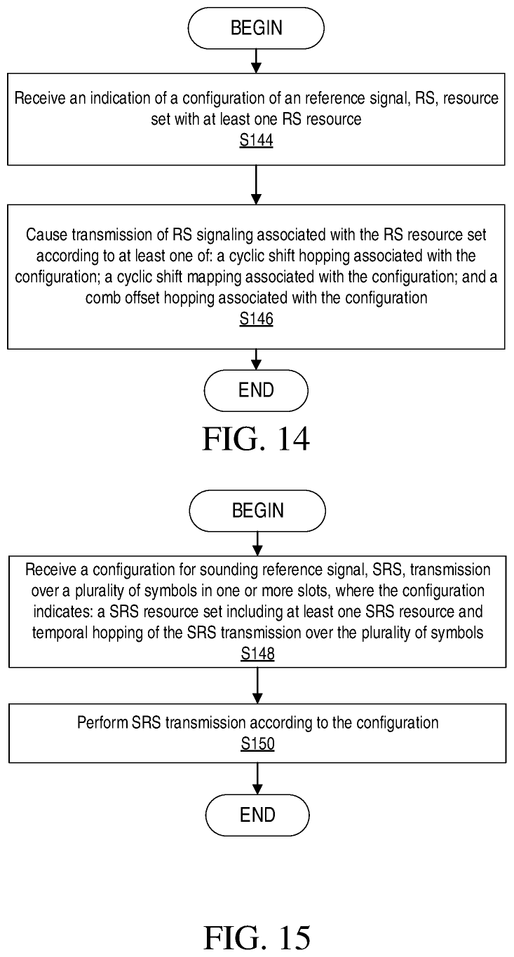

FIG. 14 is a flowchart of an example process in a WD 22 according to some embodiments of the present disclosure. One or more blocks described herein may be performed by one or more elements of WD 22 such as by one or more of processing circuitry 84 (including the RS unit 34), processor 86, radio interface 82 and/or communication interface 60. WD 22 is configured to receive (Block S144) an indication of a configuration of a RS resource set with at least one RS resource, as described herein. WD 22 is configured to cause (Block S146) transmission of RS signaling associated with the RS resource set according to at least one of a cyclic shift hopping associated with the configuration, a cyclic shift mapping associated with the configuration, and a comb offset hopping associated with the configuration, as described herein.

FIG. 15 is a flowchart of another example process in a WD 22 according to some embodiments of the present disclosure. One or more blocks described herein may be performed by one or more elements of WD 22 such as by one or more of processing circuitry 84 (including the RS unit 34), processor 86, radio interface 82 and/or communication interface 60. WD 22 is configured to receive (Block S148) a configuration for SRS transmission over a plurality of symbols in one or more slots, where the configuration indicates: a SRS resource set including at least one SRS resource and temporal hopping of the SRS transmission over the plurality of symbols, as described herein. WD 22 is configured to perform (Block S150) SRS transmission according to the configuration, as described herein.

According to some embodiments, the temporal hopping is according to a configured hopping pattern over an allocated number of at least one of cyclic shifts and comb offsets for hopping, where a subset of the allocated number of at least one of cyclic shifts and comb offsets is applied at each hop.

According to some embodiments, the configured hopping pattern is: configured one of per SRS resource and SRS resource set, and applied to a plurality of SRS ports associated with one of the at least one SRS resource and SRS resource set; and the subset of the allocated number of at least one of cyclic shifts and comb offsets is applied to the plurality of SRS ports at each hop.

According to some embodiments, the configured hopping pattern is defined by a hopping offset applied at each hop to a set of initial at least one of cyclic shifts and comb offsets configured for the plurality of SRS ports.

According to some embodiments, the hopping offset is a function of at least one of a symbol index and a slot index.

According to some embodiments, the configured hopping pattern is applied within each of the one or more slots, where the hopping is performed per symbol or per every integer number of symbols.

According to some embodiments, the configured hopping pattern is applied per slot, where the hopping is performed from slot to slot.

According to some embodiments, the configured hopping pattern is applied over the plurality of symbols in the one or more slots, where the hopping is performed per symbol or every integer number of symbols across the one or more slots.

According to some embodiments, the configured hopping pattern is a pseudo random hopping pattern.

According to some embodiments, the pseudo random hopping pattern is used to perform temporal hoping of the SRS transmission over the allocated number of at least one of cycle shifts and comb offsets.

According to some embodiments, a starting position of the pseudo random hopping pattern for the at least one SRS resource is one of: based on a configured SRS sequence for the at least one SRS resource, and based on a radio network temporary identifier, RNTI, associated with the wireless device.

According to some embodiments, the pseudo random hopping pattern is one of: the same for a plurality of SRS ports associated with the SRS resource set, the same for a plurality of SRS ports associated with the at least one SRS resource, and different from another pseudo random hopping pattern implemented for another SRS port.

Having described the general process flow of arrangements of the disclosure and having provided examples of hardware and software arrangements for implementing the processes and functions of the disclosure, the sections below provide details and examples of arrangements for reference signal resource configurations based on temporal hopping (e.g., cyclic shift hopping, comb offset hopping).

Some embodiments provide reference signal resource configurations. One or more WD 22 functions described below may be performed by one or more of processing circuitry 84, processor 86, RS unit 34, etc. One or more network node 16 functions described below may be performed by one or more of processing circuitry 68, processor 70, configuration unit 32, etc.

### Example 1 (Cyclic Shift Hopping)

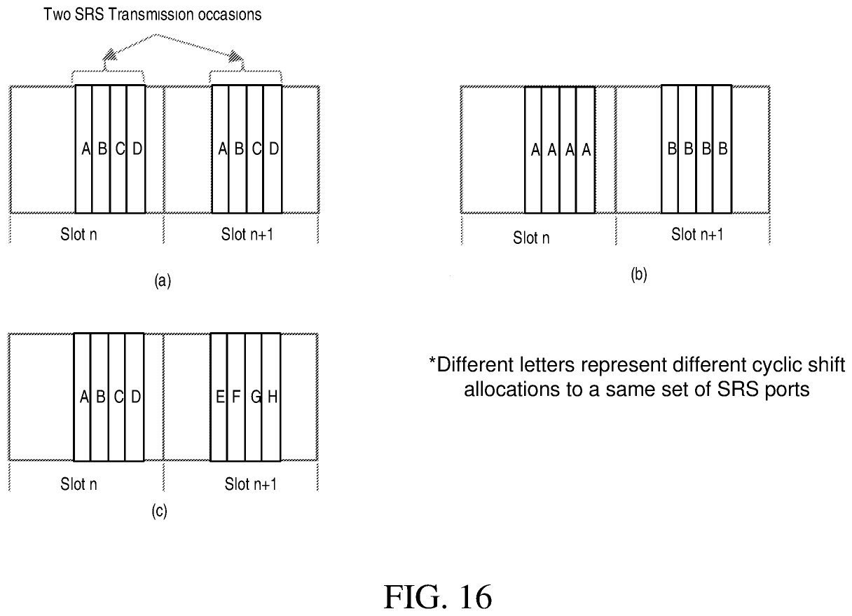

Some embodiments described herein relate to different ways of performing cyclic shift hopping over different SRS transmission (either per OFDM symbol per SRS transmission occasion, only per SRS transmission occasion, or both per OFDM symbol and per SRS transmission occasion). An example is illustrated in FIGS. 16a, 16b and 16c, where each SRS transmission occasion contains four OFDM symbols.

FIG. 16a shows an example of cyclic shift hopping per OFDM symbol per SRS transmission occasion, the cyclic shifts allocated to a set of SRS ports change over different OFDM symbols within each SRS transmission occasion.

FIG. 16b shows an example of cyclic shift hopping per SRS transmission occasion, in which case the cyclic shift allocation is unchanged over different OFDM symbols within each SRS transmission occasion, but changes from one SRS transmission occasion to another occasion.

FIG. 16c shows an example of cyclic shift hopping per OFDM symbol and per SRS transmission occasion, in which the cyclic shift allocation changes over different OFDM symbols within each SRS transmission occasion and also from one SRS transmission occasion to another SRS transmission occasion.

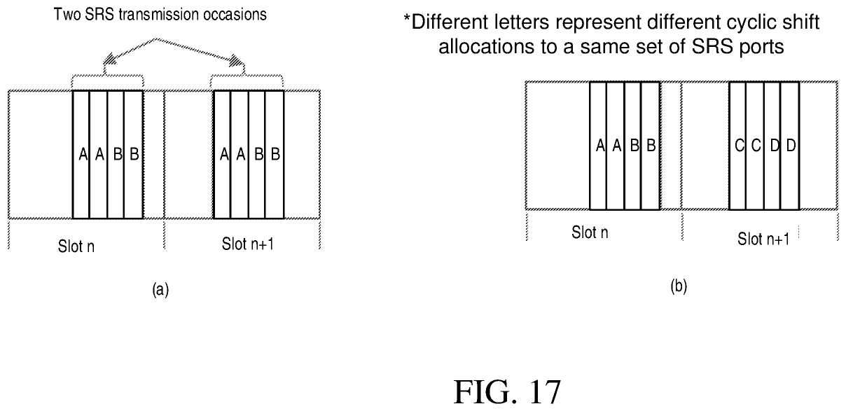

In another embodiment, cyclic shift hopping is performed over N′ consecutive (e.g., repeated) OFDM symbols per SRS transmission occasion as shown in FIG. 17a, where cyclic shift allocation changes after N′=2 OFDM symbols. The same cyclic shift hopping pattern is applied to each SRS transmission occasion. In another example, FIG. 17b shows the case where the cyclic shift allocation changes after N′=2 OFDM symbols and also across SRS transmission occasions.

In some embodiments, when cyclic shift hopping is performed over multiple SRS transmission occasions, the number of consecutive SRS transmission occasions over which cyclic shift hopping is performed is also configured as a higher layer parameter. For instance, assuming cyclic shift hopping is performed over M′=2 adjacent SRS transmission occasions and the cyclic shifts cs₁ and cs₂ are applied across the M′=2 adjacent SRS transmission occasions, then the cyclic shift hopping pattern is repeated over subsequent M′=2 adjacent transmission occasions. An example is shown below:

SRS Transmission Occasion

| | 1 | 2 | 3 | 4 | 5 | 6 |
|---|---|---|---|---|---|---|
| Cyclic Shift | cs₁ | cs₂ | cs₁ | cs₂ | cs₁ | cs₂ |
| applied | | | | | | |

In one embodiment, the number of cyclic shifts jumped or performed in each hop is a fixed number that can be indicated to the WD 22 for example per SRS resource, per SRS resource set, or per SRS port. In one embodiment, a new RRC field is introduced in SRS-Config IE described in 3GPP standard(s) such as in, for example, 3GPP TS 38.331 as described below.

| | |
|---|---|
| SRS-Resource ::= | SEQUENCE { |
| srs-ResourceId | SRS-ResourceId, |
| nrofSRS-Ports | ENUMERATED {port1, ports2, |
| | ports4}, |
| transmissionComb | CHOICE { |
| n2 | SEQUENCE { |
| combOffset-n2 | INTEGER (0..1), |
| cyclicShift-n2 | INTEGER (0..7) |
| cyclicShift-n2-hopping | INTEGER (0..7) |

},

| | |
|---|---|
| n4 | SEQUENCE { |
| combOffset-n4 | INTEGER (0..3), |
| cyclicShift-n4 | INTEGER (0..11) |
| cyclicShift-n4-hopping | INTEGER (0..11) |

[...]

In this case, all the SRS ports included in the SRS resource may hop as many cyclic shifts as configured by the parameters “cyclicShift-n2-hopping” or “cyclicShift-n2-hopping”, (either per OFDM symbol per SRS transmission occasion, only per SRS transmission occasion, both per OFDM symbol and per SRS transmission occasion, per N′ OFDM symbols per SRS transmission occasion, or per N′ OFDM symbols over M′ SRS transmission occasions). In some embodiments, the cyclic shift hopping pattern may be predefined in 3GPP specifications in a table and a row index corresponding to one of the cyclic shift hopping patterns that is configured as a RRC parameter as part of SRS-Resource in SRS-Config IE. For different values if N′ and/or M,′ different tables of cyclic shift hopping patterns may be predefined in 3GPP specifications. To indicate to the WD 22 which cyclic shift hopping pattern table to follow, the values of N′ and/or M′ may also be configured as part of SRS-Resource in SRS-Config IE.

In one embodiment, the parameters controlling the number of cyclic shifts to jump for each cyclic shift hop can be dynamically indicated by MAC-CE or DCI. For aperiodic SRS, a new bitfield could be introduced in DCI which is used to indicate the number of cyclic shifts to jump for each hop for the SRS resource set triggered by the same DCI. In this case, the network node can control how the cyclic shift hopping for different WDs 22 may be made based on the cross-SRS interference experienced during previous SRS transmissions. In a similar way, MAC-CE can be used to update the number of cyclic shifts to jump for each cyclic shift hop based on the cross-SRS interference experienced during previous SRS transmissions. The MAC-CE based solution could be applicable to, one or more of, aperiodic SRS, semi-persistent SRS and periodic SRS.

In one embodiment, the number of cyclic shifts jumped in each hop follows a pre-configured (fixed or pseudo-random) hopping pattern. For interference randomization, it may be important that different SRS resources can be configured with different hopping patterns. Indeed, if all SRS resources (configured to different WDs 22) use the same hoping pattern, the interference situation may look the same for every SRS transmission occasion. Hence, it may be important that a WD 22 can be configured with a specific start position in hopping pattern, referred to as a “Pseudo random CS hopping pattern offset”. In one embodiment the “Pseudo random CS hopping pattern offset” is implicitly indicated for a certain WD 22 based on for example the RNTI or the configured Sequence ID for a certain SRS resource. In one embodiment, the “Pseudo random CS hopping pattern offset” is explicitly configured for a WD 22, either per WD 22, or per serving cell, or per UL BWP, or per SRS resource set, or per SRS resource, or per SRS port. One schematic example of how this might look is illustrated below.

The “Pseudo random CS hopping pattern offset” is configured per SRS resource as shown below:

| | |
|---|---|
| SRS-Resource ::= | SEQUENCE { |
| srs-ResourceId | SRS-ResourceId, |
| nrofSRS-Ports | ENUMERATED {port1, ports2, |
| | ports4}, |

PseudoRandomCSHoppingPatternOffset INTEGER (0..N),

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

[...]

In one embodiment, the WD 22 is only expected to be configured with a number of cyclic shifts per hop that is smaller than the total number of cyclic shifts for that SRS resource divided by number of SRS Ports for that SRS resource.

In one embodiment, whether the pre-configured pseudo random hopping pattern for cyclic shifts should be applied or not for a WD 22 could be dynamically indicated by MAC-CE or DCI. For aperiodic SRS, a new bitfield could be introduced in DCI which is used to turn on/off the pre-configured pseudo random hopping pattern for an SRS resource set triggered by the same DCI. In this case, the network node 16 can control how the cyclic shift hopping are performed for different WD 22 based on the cross-SRS interference experienced during previous SRS transmissions. In a similar way, MAC-CE can be used to turn on/off pre-configured pseudo random hopping pattern of cyclic shifts based on the cross-SRS interference experienced during previous SRS transmissions. The MAC-CE based solution could be applicable to, one or more of, aperiodic SRS, semi-persistent SRS, and periodic SRS.

In one embodiment, the network node 16 RRC-configures, e.g., a Boolean parameter specifying whether cyclic-shift hopping is enabled or disabled as shown below.

| | |
|---|---|
| SRS-Resource ::= | SEQUENCE { |
| srs-ResourceId | , |
| nrofSRS-Ports | ENUMERATED {port1, ports2, ports4}, |
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

}

| | |
|---|---|
| n8-r17 | SEQUENCE { |
| combOffset-n4-r17 | INTEGER (0..7), |
| cyclicShift-n4-r17 | INTEGER (0..5) |

}

| | |
|---|---|
| enableCyclicShiftHopping | ENUMERATED(enable) |

[...]

In this case, a predefined cyclic-shift hopping pattern to use is determined using legacy RRC parameters (e.g., the SRS sequence ID, the configured cyclic shift, etc.)

Next, several examples are provided of how existing NR SRS formulas/specification can be updated to support cyclic-shift hopping.

In legacy (i.e., 3GPP Rel-16) NR, the cyclic shift a; for antenna port p; is given by

$${α}_{i} = 2 π \frac{{n}_{SRS}^{cs , i}}{{n}_{SRS}^{cs , m ax}} \\ {n}_{SRS}^{cs , i} = \{ \begin{matrix}( {n}_{SRS}^{cs} + \frac{{n}_{SRS}^{cs , m ax} ⌊ ( {p}_{i} - 10 \; 00 ) / 2 ⌋}{{N}_{ap}^{SRS} / 2} ) mod {n}_{SRS}^{cs , m ax} & if {N}_{ap}^{SRS} = 4 and {n}_{SRS}^{cs , m ax} = 6 \\ ( {n}_{SRS}^{cs} + \frac{{n}_{SRS}^{cs , m ax} ( {p}_{i} - 1000 )}{{N}_{ap}^{SRS}} ) mod {n}_{SRS}^{cs , m ax} & otherwise\end{matrix}$$

where n_{SRS}^{cs}∈{0,1, . . . , n_{SRS}^{cs,max}−1} is contained in the higher layer parameter transmissionComb (i.e., the RRC-configured cyclic shift for that SRS resource). The maximum number of cyclic shifts n_{SRS}^{cs,max}.

In one embodiment, if cyclic-shift hopping is enabled, the formulas above are updated as follows:

$${α}_{i} = 2 π \frac{{n}_{SRS}^{cs , i}}{{n}_{SRS}^{cs , m ax}} \\ {n}_{SRS}^{cs , i} = \{ \begin{matrix}( {\tilde{n}}_{SRS}^{cs} + \frac{{n}_{SRS}^{cs , m ax} ⌊ ( {p}_{i} - 10 \; 00 ) / 2 ⌋}{{N}_{ap}^{SRS} / 2} ) mod {n}_{SRS}^{cs , m ax} & if {N}_{ap}^{SRS} = 4 and {n}_{SRS}^{cs , m ax} = 6 \\ ( {\tilde{n}}_{SRS}^{cs} + \frac{{n}_{SRS}^{cs , m ax} ( {p}_{i} - 1000 )}{{N}_{ap}^{SRS}} ) mod {n}_{SRS}^{cs , m ax} & otherwise\end{matrix} \\ where \\ {\tilde{n}}_{SRS}^{cs} = {n}_{SRS}^{cs} + {f}_{csh} ( {l}^{′} , {n}_{s , f}^{μ} )$$

Here, ƒ_{csh}(l′, n_{s,f}^{μ}) is the cyclic-shift hopping function, l′=0,1, . . . , N_{symb}^{SRS}−1 is the SRS symbol within a slot, and n_{s,f}^{μ} is the slot number within a frame for subcarrier configuration μ.

In one embodiment, if cyclic-shift hopping is not enabled ƒ_{csh}(l′, n_{s,f}^{μ})=ƒ_{csh}=0.

In one embodiment, the cyclic-shift hopping function is the same over all slots, i.e., ƒ_{csh}(l′, n_{s,f}^{μ})=ƒ_{csh}(l′). In one example of this embodiment (note that there are various different ways to implement cyclic-shift hopping), the cyclic-shift hopping function is given by

$${f}_{csh} ( {l}^{′} ) = ⌊ \frac{{n}_{SRS}^{cs , m ax}}{{N}_{symb}^{SRS}} ⌋ ( 2 \cdot mod ( {n}_{SRS}^{cs} , 2 ) - 1 ) {l}^{′}$$

This may at least help ensure that SRS resources configured with an odd number of n_{SRS}^{cs} will use different cyclic shifts in different SRS symbols.

Next, to illustrate the use of randomizing SRS interference via cyclic-shift hopping, an example is described for which k_{TC}=2 such that n_{SRS}^{cs,max}=8. In this example, eight 1-port SRS resources numbered 0-7 are scheduled on the same bandwidth, on the same comb offset, and over the same N_{symb}^{SRS}=4 symbols. In this example, SRS resource n is configured with n_{SRS}^{cs}=n. However, due to the delay spread of the channel, cyclic shift n_{SRS}^{cs,i}=n suffers from cross-SRS interference from cyclic shift n_{SRS}^{cs,i}=n−1, which is assigned to SRs resource n−1. Below, is a list of the occupied cyclic shifts for each SRS resource with (i.e., according to the above formulas) and without cyclic-shift hopping:
1-port SRS resource 0 is configured with n_{SRS}^{cs}=0
   With/without cyclic shift hopping: n_{SRS}^{cs,i}=0,0,0,0.
1-port SRS resource 1 is configured with n_{SRS}^{cs}=1
   Without cyclic shift hopping: n_{SRS}^{cs,i}=1,1,1,1
   With cyclic shift hopping: n_{SRS}^{cs,i}=1,3,5,7
1-port SRS resource 2 is configured with n_{SRS}^{cs}=2
   With/without cyclic shift hopping: n_{SRS}^{cs,i}=2,2,2,2
1-port SRS resource 3 is configured with n_{SRS}^{cs}=3
   Without cyclic shift hopping: n_{SRS}^{cs,i}=3,3,3,3
   With cyclic shift hopping: n_{SRS}^{cs,i}=3,5,7,1.
1-port SRS resource 4 is configured with n_{SRS}^{cs}=4
   With/without cyclic shift hopping: n_{SRS}^{cs,i}=4,4,4,4.
1-port SRS resource 5 is configured with n_{SRS}^{cs}=5
   Without cyclic shift hopping: n_{SRS}^{cs,i}=5,5,5,5
   With cyclic shift hopping: n_{SRS}^{cs,i}=5,7,1,3
1-port SRS resource 6 is configured with n_{SRS}^{cs}=6
   With/without cyclic shift hopping: n_{SRS}^{cs,i}=6,6,6,6
1-port SRS resource 7 is configured with n_{SRS}^{cs}=7
   Without cyclic shift hopping: n_{SRS}^{cs,i}=7,7,7,7
   With cyclic shift hopping: n_{SRS}^{cs,i}=7,1,3,5

With cyclic shift hopping, the set of adjacent cyclic shifts for an SRS resource is different in each of the N_{symb}^{SRS}=4 symbols. For example, for SRS resource 2, the interfering SRS resource is SRS resource 1 in the first symbol, SRS resource 7 in the second symbol, SRS resource 5 in the third symbol, and SRS resource 3 in the fourth symbol. This is in contrast to legacy NR (i.e., no cyclic-shift hopping) where SRS resource 2 would suffer interference from SRS resource 1 over all 4 SRS symbols. Hence, interference would add up constructively when combining the SRS received over the multiple symbols without cyclic shift hopping, whereas interference adds up non-constructively with cyclic shift hopping.

In one embodiment, the cyclic shift hopping pattern is determined according to a predefined table.

In one example of this embodiment, the cyclic shift hopping pattern (e.g., tabulated or according to a predefined function) only spans a subset (e.g., half) of the n_{SRS}^{cs,max} cyclic shifts, such that legacy SRS resources can be configured with cyclic shifts in the remaining set of cyclic shifts without interfering with new SRS resources that are configured with cyclic shift hopping. Note that this is the case in the example above. Indeed, no cyclic shift hopping takes place in the even-numbered cyclic shifts. Hence, these could be assigned to legacy WDs 22 that does not support cyclic shift hopping or to WDs 22 that support cyclic shift hopping but are not configured with cyclic shift hopping.

In one embodiment, if SRS repetition is configured (with/without frequency hopping) with 1<R<N_{SRS}^{symb}, the cyclic shift does not hop before R SRS symbols are sounded. In this case, e.g., it holds that

$${\tilde{n}}_{SRS}^{cs} = {n}_{SRS}^{cs} + {f}_{csh} ( {n}_{SRS} )$$

Here, n_{SRS} count the number of non-repeated SRS symbols (for aperiodic SRS, n^{SRS}=└l′/R┘).

In another embodiment, the cyclic shift hopping pattern may be designed by adding a shift to the existing cyclic shift index n_{SRS}^{cs,i}, i.e., the cyclic shift αᵢ for antenna port pᵢ is given by

$${α}_{i} = 2 π \frac{( {n}_{SRS}^{cs , i} + {f}_{csh} ( {l}^{′} , {n}_{s , f}^{μ} ) ) mod {n}_{SRS}^{cs , m ax}}{{n}_{SRS}^{cs , m ax}}$$

where ƒ_{csh}(l′, n_{s,f}^{μ}) is a pre-defined cyclic shift hopping pattern and is a function of OFDM symbol index and slot index within a radio frame, l′ is the OFDM symbol index within a SRS transmission occasion. Alternatively, l′ can be the OFDM symbol index within in a slot. In case of cyclic shift hopping within each SRS transmission occasion, ƒ_{csh}(l, n_{s,f}^{μ})=ƒ_{csh}(l). In case of cyclic shift hopping per SRS transmission occasion, ƒ_{csh}(l, n_{s,f}^{μ})=ƒ_{csh}(n_{s,f}^{μ}).

### Example 2 (Comb Offset Hopping)

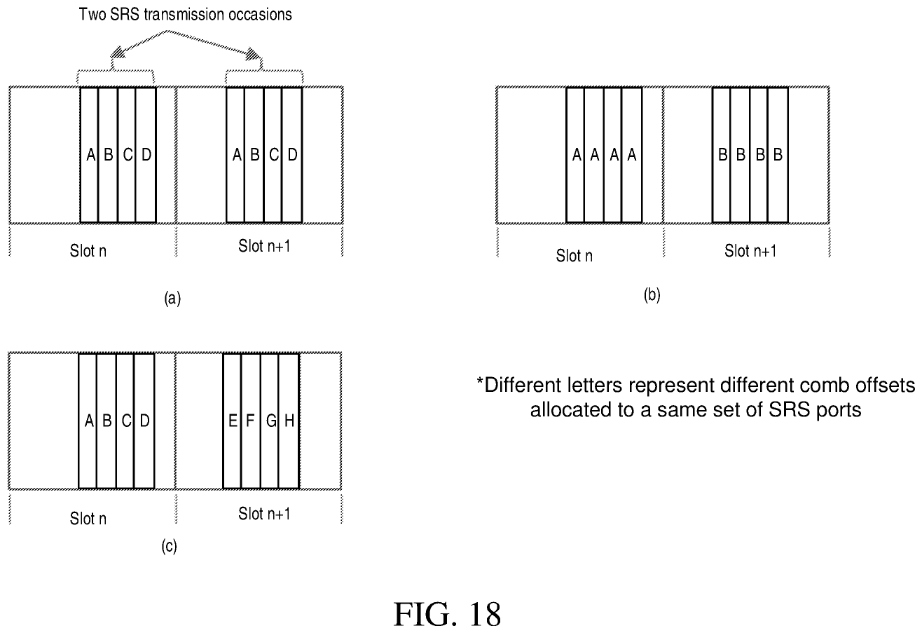

In these embodiments, there is provided different ways of performing comb offset hopping over different SRS transmission (either per OFDM symbol per SRS transmission occasion, only per SRS transmission occasion, or both per OFDM symbol and per SRS transmission occasion). An example is illustrated in FIGS. 18a, 18b and 18c, where each SRS transmission occasion contains four OFDM symbols.

FIG. 18a shows an example of comb offset hopping per OFDM symbol per SRS transmission occasion, where the comb offset allocated to a set of SRS ports changes over different OFDM symbols within each SRS transmission occasion. FIG. 18b shows an example of comb offset hopping per SRS transmission occasion, in which the comb offset allocation is unchanged over different OFDM symbols within each SRS transmission occasion, but changes from one SRS transmission occasion to another occasion. FIG. 18c shows an example of comb offset hopping per OFDM symbol and per SRS transmission occasion, in which the comb offset allocation changes over different OFDM symbols within each SRS transmission occasion and also from one SRS transmission occasion to another SRS transmission occasion.

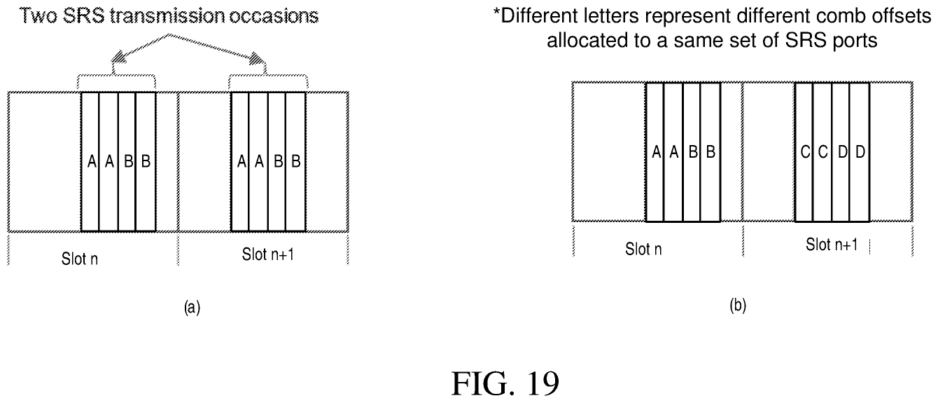

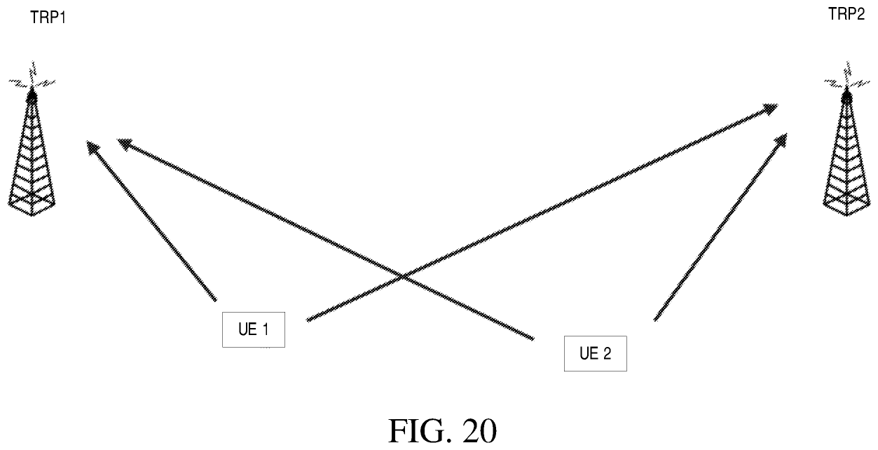

In another embodiment, comb offset hopping is performed over P′ consecutive OFDM symbols per SRS transmission occasion as shown in FIG. 19a, where the comb offsets are hopped over N′=2 OFDM symbols. The same comb offset hopping pattern is applied to each SRS transmission occasion. In another embodiment shown in FIG. 19b, the comb offsets are hopped over P′=2 OFDM symbols and also across SRS transmission occasions.

In some embodiments, when comb offset hopping is performed over SRS transmission occasions, the number of consecutive SRS transmission occasions over which comb offset hopping is performed is also configured as a higher layer parameter. For instance, assuming comb offset hopping is performed over Q′=2 adjacent SRS transmission occasions and the comb offsets comb₁ and comb₂ are applied across the Q′=2 adjacent SRS transmission occasions, then the comb offset hopping pattern is repeated over subsequent Q′=2 adjacent transmission occasions. An example is shown below:

| | SRS Transmission Occasion | | | | | |
|---|---|---|---|---|---|---|
| | 1 | 2 | 3 | 4 | 5 | 6 |
| comb offset | comb₁ | comb₂ | comb₁ | comb₂ | comb₁ | comb₂ |
| applied | | | | | | |

In one embodiment, the number of comb offsets jumped in each hop is a fixed number that can be indicated to the WD 22, for example, per SRS resource, SRS resource set or per SRS port. In one embodiment, a new RRC field is introduced in SRS config IE as schematically as shown below.

| | |
|---|---|
| SRS-Resource ::= | SEQUENCE { |
| srs-ResourceId | SRS-ResourceId, |
| nrofSRS-Ports | ENUMERATED {port1, ports2, |
| | ports4}, |
| transmissionComb | CHOICE { |
| n2 | SEQUENCE { |
| combOffset-n2 | INTEGER (0..1), |
| cyclicShift-n2 | INTEGER (0..7) |
| combOffset-n2-hopping | INTEGER (0..7) |

},

| | |
|---|---|
| n4 | SEQUENCE { |
| combOffset-n4 | INTEGER (0..3), |
| cyclicShift-n4 | INTEGER (0..11) |
| combOffset-n4-hopping | INTEGER (0..11) [...] |

In this case, all the SRS ports included in the SRS resource may hop as many comb offsets as configured by the parameters “combOffset-n2-hopping” or “combOffset-n2-hopping”, (either per OFDM symbol per SRS transmission occasion, only per SRS transmission occasion, both per OFDM symbol and per SRS transmission occasion, per P′ OFDM symbols per SRS transmission occasion, or per P′ OFDM symbols over Q′ SRS transmission occasions). In some embodiments, the comb offset hopping pattern may be predefined in 3GPP specifications in a table and a row index corresponding to one of the comb offset hopping patterns that is configured as a RRC parameter as part of SRS-Resource in SRS-Config IE. For different values if P′ and/or Q,′ different tables of comb offset hopping patterns may be predefined in 3GPP specifications. To indicate to the WD 22 which comb offset hopping pattern table to follow, the values of P′ and/or Q′ may also be configured as part of SRS-Resource in SRS-Config IE.

In one embodiment, the parameters controlling the number of comb offsets to jump for each comb offset hop can be dynamically indicated by MAC-CE or DCI. For aperiodic SRS, a new bitfield could be introduced in DCI which is used to indicate the number of comb offsets to jump for each hop for the SRS resource set triggered by the same DCI. In this case, the network node 16 can control how the comb offset hopping for different WDs 22 may be made based on the cross-SRS interference experienced during previous SRS transmissions. In a similar way, a MAC-CE can be used to update the number of comb offsets to jump for each comb offset hop based on the cross-SRS interference experienced during previous SRS transmissions. The MAC-CE based solution could be applicable to one or more of: aperiodic SRS, semi-persistent SRS and periodic SRS.

In one embodiment, the number of comb offsets jumped in each hop follows a pre-configured pseudo random hopping pattern. For properly randomizing the interference, it may be important that different WDs 22 use different kinds of pseudo random hopping patterns, since if each WD 22 uses the same pseudo random hoping pattern, the interference situation may be similar or the same for every SRS transmission occasion. Hence, it may be important that a WD 22 can be configured with a specific start position in the pseudo random hopping pattern, referred to as a “Pseudo random comb offset hopping pattern offset”. In one embodiment, the “Pseudo random comb offset hopping pattern offset” is implicitly indicated for a certain WD 22 based on, for example, the RNTI or the configured Sequence ID for a certain SRS resource. In one embodiment, the “Pseudo random comb offset hopping pattern offset” is explicitly configured for a WD 22, either per WD 22, or per serving cell, or per UL BWP, or per SRS resource set, or per SRS resource, or per SRS port. One schematic example is shown below, where the “Pseudo random comb offset hopping pattern offset” is configured per SRS resource.

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| PseudoRandomCombOffsetHoppingPatternOffset | INTEGER (0..N), |
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

[...]

In one embodiment, the WD 22 is only expected to be configured with a number of comb offsets per hop that is smaller than the comb factor for that SRS resource.

In one embodiment, whether the pre-configured pseudo random hopping pattern for cyclic shifts should be applied or not for a WD 22 could be dynamically indicated by MAC-CE or DCI. For aperiodic SRS, a new bitfield could be introduced in DCI which is used to turn on/off the pre-configured pseudo random hopping pattern for an SRS resource set triggered by the same DCI. In this case, the network node 16 can control how the cyclic shift hopping is performed for different WDs 22 based on the cross-SRS interference experienced during previous SRS transmissions. In a similar way, MAC-CE can be used to turn on/off the pre-configured pseudo random hopping pattern of cyclic shifts based on the cross-SRS interference experienced during previous SRS transmissions. The MAC-CE based solution could be applicable to one or more of: aperiodic SRS, semi-persistent SRS and periodic SRS

In another embodiment, the existing comb offset is configured for each WD 22 is the initial comb offset. The actual comb offset k_{TC}^{(p}^{ᵢ}⁾(l′, n_{s,f}^{μ}) for SRS port pᵢ in a SRS resource is an OFDM symbol l′ of slot n_{s,f}^{μ} that is determined by

$${k}_{TC}^{( {p}_{i} )} ( {l}^{′} , {n}_{s , f}^{μ} ) = ( {k}_{TC , 0}^{( {p}_{i} )} + k ( {l}^{′} , {n}_{s , f}^{μ} ) ) mod {K}_{TC}$$

where k_{TC,0}^{(p}^{ᵢ}⁾ is the configured comb offset for the SRS resource, K_{TC} is the total number of comb offsets (e.g., 2 or 4) configured in a cell, and k(l′, n_{s,f}μ) is a hopping pattern.

In one example of this embodiment, the comb-offset hopping pattern (e.g., tabulated or according to a predefined function) may only span a subset (e.g., half) of the available comb offset, such that legacy SRS resources can be configured with comb offsets in the remaining set of comb offsets without interfering with new SRS resources that are configured with comb-offset hopping.

### Example 3 (New Cyclic Shift Mapping within SRS Resource)

In these embodiments, a new cyclic shift mapping rule over SRS ports belonging to the same SRS resource is provided, where this new cyclic shift mapping rule may be more suitable for multi-TRP operation than other procedures. The legacy cyclic shift mapping rule aims to separate the cyclic shifts between different SRS ports of the same SRS resource as much as possible to maximize the robustness against delay spread for the different SRS ports. If this WD 22 is the only WD 22 using a certain comb and comb offset, at a certain SRS transmission occasion, the legacy cyclic shift mapping rule may be optimal since it maximizes the robustness to delay spread. However, in case more than one WD 22 is transmitting SRS at the same time using the same comb and comb offset, then the legacy cyclic shift mapping rules become sub-optimal, since in many cases the difference in delay between SRS ports of different WDs 22 are larger than the difference in delay between different SRS Ports of the same WD 22. This is especially true for multi-TRP operation where different WDs 22 can have different delays to different TRPs. One example of this is illustrated in FIG. 20, where UE1 (a WD 22) has a large delay towards TRP2 and short delay towards TRP1, while UE2 (a WD 22) has a short delay towards TRP 2 and long delay towards TRP1. In this case, using the legacy cyclic shift mapping, where the robustness between SRS ports are maximized between different SRS port per TRP is sub-optimal, since the delay between the SRS ports of different UEs/WDs 22 is significantly larger.

In one embodiment, the new cyclic shift mapping rule is defined where SRS ports of the same SRS resource have less cyclic shifts between them compared to the legacy cyclic shift mapping rule. For example, for a two port SRS resource with comb 4, the two SRS ports may be associated with for example cyclic shift 0 and cyclic shift 6. In the new cyclic shift mapping rule, the two SRS ports can instead be associated with cyclic shifts 0 and cyclic shift N, where N is a number smaller than 6.

In one embodiment, the number of cyclic shifts between SRS ports of an SRS resource can be explicitly configured for a WD 22, either per WD 22, or per serving cell, or per UL BWP, or per SRS resource set, or per SRS resource, or per SRS port. One schematic example is shown below, where the number of cyclic shifts between adjacent SRS ports is configured per SRS resource in the parameters “cyclicShift-n2-separation” and “cyclicShift-n4-separation”.

| | |
|---|---|
| SRS-Resource ::= | SEQUENCE { |
| srs-ResourceId | SRS-ResourceId, |
| nrofSRS-Ports | ENUMERATED {port1, ports2, |
| | ports4}, |
| transmissionComb | CHOICE { |
| n2 | SEQUENCE { |
| combOffset-n2 | INTEGER (0..1), |
| cyclicShift-n2 | INTEGER (0..7) |
| cyclicShift-n2-separation | INTEGER (0..7) |

},

| | |
|---|---|
| n4 | SEQUENCE { |
| combOffset-n4 | INTEGER (0..3), |
| cyclicShift-n4 | INTEGER (0..11) |
| cyclicShift-n4-separation | INTEGER (0..11) |

[...]

In one embodiment, the number of cyclic shifts between SRS ports of an SRS resource can be dynamically updated using MAC-CE or DCI.

Even though cyclic shift hopping, and comb hopping are discussed separately, they may be used together with SRS repetition or frequency hopping to improve interference randomization.

Note that one or more of the three embodiments above can be combined (i.e., configured at the same time).

Hence, one or more embodiments described herein provide one or more of the following advantages:
The cyclic-shift and/or comb-offset methods randomize the cross-SRS interference, which, in turn, improves the CSI quality at one or more TRP(s).
In addition, the cyclic-shift allocation pattern between ports of a same SRS resource (belonging to a same wireless device 22) reduces cross-SRS interference between different WDs 22 in multi-TRP operation. This may be important, since the delay between different WDs 22 is expected to be larger than the delay between different ports of one WD 22 (which could be even further aggravated in multi-TRP scenarios, where different WDs 22 might be time-aligned to different TRPs).

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. A variety of modifications and variations are possible in light of the above teachings without departing from the scope of the following claims.

1. A network node in communication with a wireless device, the network node comprising:
processing circuitry configured to:
cause transmission of a configuration to a wireless device for sounding reference signal, SRS, transmission over a plurality of symbols in one or more slots, the configuration indicating:
a SRS resource set including at least one SRS resource; and
temporal hopping of the SRS transmission over the plurality of symbols;
receive the SRS transmission according to the configuration; and
perform SRS measurements based on the received SRS transmission.

2. The network node of claim 1, wherein the temporal hopping is according to a configured hopping pattern over an allocated number of at least one of cyclic shifts and comb offsets for hopping, wherein a subset of the allocated number of at least one of cyclic shifts and comb offsets is applied at each hop.

3. The network node of claim 2, wherein the configured hopping pattern is:
configured one of per SRS resource and SRS resource set; and
applied to a plurality of SRS ports associated with one of the at least one SRS resource and SRS resource set; and
the subset of the allocated number of at least one of cyclic shifts and comb offsets is applied to the plurality of SRS ports at each hop.

4. The network node of claim 2, wherein the configured hopping pattern is defined by a hopping offset applied at each hop to a set of initial at least one of cyclic shifts and comb offsets configured for the plurality of SRS ports.

5. The network node of claim 4, wherein the hopping offset is a function of at least one of a symbol index and a slot index.

6. The network node of claim 2, wherein the configured hopping pattern is applied within each of the one or more slots, wherein the hopping is performed per symbol or per every integer number of symbols.

7. The network node of claim 2, wherein the configured hopping pattern is applied per slot, wherein the hopping is performed from slot to slot.

8. The network node of claim 2, wherein the configured hopping pattern is applied over the plurality of symbols in the one or more slots, wherein the hopping is performed per symbol or every integer number of symbols across the one or more slots.

9.-12. (canceled)

13. A wireless device in communication with a network node, the wireless device comprising:
processing circuitry configured to:
receive a configuration for sounding reference signal, SRS, transmission over a plurality of symbols in one or more slots, the configuration indicating:
a SRS resource set including at least one SRS resource; and
temporal hopping of the SRS transmission over the plurality of symbols; and
perform SRS transmission according to the configuration.

14. The wireless device of claim 13, wherein the temporal hopping is according to a configured hopping pattern over an allocated number of at least one of cyclic shifts and comb offsets for hopping, wherein a subset of the allocated number of at least one of cyclic shifts and comb offsets is applied at each hop.

15. The wireless device of claim 14, wherein the configured hopping pattern is:
configured one of per SRS resource and SRS resource set;
applied to a plurality of SRS ports associated with one of the at least one SRS resource and SRS resource set; and
the subset of the allocated number of at least one of cyclic shifts and comb offsets is applied to the plurality of SRS ports at each hop.

16. The wireless device of claim 14, wherein the configured hopping pattern is defined by a hopping offset applied at each hop to a set of initial at least one of cyclic shifts and comb offsets configured for the plurality of SRS ports.

17. The wireless device of claim 16, wherein the hopping offset is a function of at least one of a symbol index and a slot index.

18. The wireless device of claim 14, wherein the configured hopping pattern is applied within each of the one or more slots, wherein the hopping is performed per symbol or per every integer number of symbols.

19. The wireless device of claim 14, wherein the configured hopping pattern is applied per slot, wherein the hopping is performed from slot to slot.

20. The wireless device of claim 14, wherein the configured hopping pattern is applied over the plurality of symbols in the one or more slots, wherein the hopping is performed per symbol or every integer number of symbols across the one or more slots.

21. The wireless device of claim 14, wherein the configured hopping pattern is a pseudo random hopping pattern.

22. The wireless device of claim 21, wherein the pseudo random hopping pattern is used to perform temporal hoping of the SRS transmission over the allocated number of at least one of cycle shifts and comb offsets.

23. The wireless device of claim 21, wherein a starting position of the pseudo random hopping pattern for the at least one SRS resource is one of:
based on a configured SRS sequence for the at least one SRS resource; and
based on a radio network temporary identifier, RNTI, associated with the wireless device.

24. (canceled)

25. (canceled)

26. A method implemented by a wireless device that is configured to communicate with a network node, the method comprising:
receiving a configuration for sounding reference signal, SRS, transmission over a plurality of symbols in one or more slots, the configuration indicating:
a SRS resource set including at least one SRS resource; and
temporal hopping of the SRS transmission over the plurality of symbols; and
performing SRS transmission according to the configuration.
